(19) United States
(12) Patent Application Publication
(10) Pub. No.: US 2006/0284382 A1
(43) Pub. Date: Dec. 21, 2006

(54) Multi-layer metallic flat gasket

(76) Inventors: Andreas Gottler, Ulm (DE); Kurt Hohe, Langenau (DE); Bernd Ruess, Vohringen (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/454,413

(22) Filed: Jun. 16, 2006

(30) Foreign Application Priority Data
Jun. 16, 2005 (EP) 05013061.6

(51) Int. Cl. F02F 11/00

(52) U.S. Cl. 277/598

(57) ABSTRACT

A metallic flat gasket is disclosed. The gasket includes at least two superimposed gasket layers which are connected to each other within at least one connecting area. A through opening is provided in the connecting area of each of the two gasket layers, with at least one projection in each case extending from the margin of the through opening into its interior. The projection is connected to the respective gasket layer, with the connection between the two gasket layers in the connecting area achieved by the at least one projection of the first gasket layer and the at least one projection of the second gasket layer. The projection of the first gasket layer is designed so as not to overlap with the at least one projection of the second gasket layer in a projection into the plane of the second gasket layer. The projection of the first gasket layer is deformed at least in certain areas out of the plane of the first gasket layer in a direction towards the second gasket layer until at least one outer margin portion of the projection comes to lie in a plane behind an adjacent outer margin portion of the second gasket layer, and subsequently by at least one of the adjacent outer margin portions being calked so that the projection of the first gasket layer grasps behind the projection of the second gasket layer within the area of the adjacent outer margin portions. The invention further relates to a method for connecting the gasket layers.

### CROSS-REFERENCE TO RELATED APPLICATIONS

Under 35 U.S.C. 119, this application claims the benefit of European Patent Application No. EP05013061.6, filed Jun. 16, 2005.

### TECHNICAL FIELD

The disclosure relates to a metallic flat gasket having at least two superimposed gasket layers which are joined to each other within at least one connecting area. The connection of the gasket layers among each other is used for facilitating handling and fixes the individual gasket layers in a pre-determined orientation with respect to each other.

### BACKGROUND

Gasket layers are frequently welded or riveted together. Both processes for joining are relatively slow however. Welding also comes with the disadvantage that it requires a high amount of maintenance and can only be used in gasket layers which are not provided with a coating made of plastic. In the case of a riveted connection, additional components are required with the rivets which increase the costs for the gasket. A further disadvantage is that as a result of the riveted connection an enlargement of the material occurs. This enlargement of the material can lead to an impairment of the sealing function when it is located in the pressing zone, i.e. in the area of the sealing surface which comes to lie between the counter-surfaces to be sealed. For this reason, such or similar layered connections which lead to an enlargement of the material are usually arranged on connection flaps which project beyond the outside shape of the gasket. Such connection flaps require additional material, which raises the price of the gasket and can also impair the ability to handle the gasket.

Layer connections are known in which the connections are made without additional connecting elements such as rivets. A through opening is provided, for example, for this purpose in one of the gasket layers, through which a fastening flap of the adjacent gasket layer is guided and on which the boundary region of the other gasket layer enclosing the through opening is bent back in order to thus clamp the two gasket layers together. This solution comes with the disadvantage however that an enlargement of material is produced in the boundary region of the through opening. For these reasons, these connections are arranged on connecting flaps which project beyond the outside contour of the gasket, as is described, for example, in DE 20110331 U1. The disadvantages as described above occur with the use of the connecting flaps.

Such connecting techniques are principally more advantageous in which there is no enlargement of the material in the connecting area and which therefore can be used within the pressing area of the gasket. Such a layer connection is described in DE 19823115 C1, for example. Several substantially rectangular connecting areas are present in the pressing area. In a first gasket layer, the respective connecting area comprises a recess which corresponds approximately to the surface area of the rectangular connecting area. Bow-like projections project into the recesses at opposite longitudinal sides of the rectangle, so that a dog-bone-like opening is obtained in its entirety. Two parallel slots are punched into the adjacent gasket layer in the region which is opposite of the opening, the position of which corresponds substantially to the position of the longitudinal sides of the rectangle in the adjacent layer. For the purpose of joining the two gasket layers, the strip which is still connected on its face side with the gasket layer is pressed in the direction towards the adjacent gasket layer and pushed past the bow-like projections projecting into the opening, so that the strip latches behind the bowlike projections. The two gasket layers are mutually joined and mutually fixed as a result of the latched connection thus produced. The disadvantageous aspect in this type of connection is however that the individual connecting points do not allow any displacement-proof positioning of the two gasket layers with respect to each other. To produce the latched connection it is also necessary to use material which is sufficiently resiliently elastic and returns again to a sufficient extent. Inadvertent detachment of the latched connection is also not completely excluded because the elastic joint can also deform back again under a respective action of form and thus can detach.

### SUMMARY

A first embodiment includes a metallic flat gasket with at least two superimposed gasket layers which are joined to each other within at least one connecting area. For this purpose, a through opening is present in the connecting area in each of the two gasket layers, from the edge of which at least one projection connected to the respective gasket layer projects into the interior of the through opening. The connection between the two gasket layers in the connecting area can be obtained in such a way that the at least one projection of the first gasket layer is deformed at least partly from the plane of the first gasket layer in the direction towards the second gasket layer. The projection is configured prior to the deformation in such a way that, when viewed in the projection into the plane of the second gasket layer, it does not overlap with the at least one projection present in said gasket layer. The projection of the first gasket layer is deformed until at least one of its outer margin portions comes to lie in a plane behind an adjacent outer margin portion of a projection of the second gasket layer. Thereafter, at least one of the adjacent outer margin portions is calked in such a way that the projection of the first gasket layer grasps behind the projection of the second gasket layer in the region of the adjacent outer margin portions.

As a result of the undercut of the first gasket layer behind the second gasket layer described above, both gasket layers are rigidly connected to each other. As a result, the connection in accordance with the invention differs from the latched connections as described in DE 19823115 C1, especially in such away that in the invention the connection between the gasket layers is not produced by elastic latching, but by calking at least one of the outer margin portions of the projections of the two gasket layers used for joining. As a result of the calking, material is pressed from the outer margin portion of the projection to the side beyond the outside edge of the projection. The undercut of the projection of the other gasket layer is thus not produced by an elastic deformation of the material of the projection, but as a result of plastic deformation. As a result of this, the connection of the two gasket layers is considerably more stable in the case of the invention than in the case of the elastic latched connections of the state of the art. Moreover, the connection technique in accordance with the invention can be used in a more versatile manner because it does not require any elastic material as the starting material for the gasket layers. All metallic materials are principally suitable, even when they show no or only very little elastic properties. Examples of suitable metallic materials are all high-grade steels, carbon steels or spring steels.

The advantageous aspect in the metal flat gasket in accordance with the invention is further that the connection between the gasket layers can be arranged in the pressing region of the flat gasket, because the connection of both gasket layers in accordance with the invention does not lead to an enlargement of the material in this region. The undercut connection between the two gasket layers is received in the connecting area in the area of the through openings without material projecting beyond the surfaces of the two mutually joined gasket layers. Even if merely a projection of one of the gasket layers is bent up in the direction towards the other gasket layer for producing the connection between the two gasket layers and the projection which is to be grasped behind by the formed projection remains in a plane at first and thus the formed projection initially projects beyond the plane of the opposite gasket layer, the connected projections can thereafter be bent back to the through openings. In the connecting area, so that they do not project any more at any side beyond the surfaces of the connected gasket layers. This centering of the projections in the region of the through openings in the connecting area can occur actively by pressing the projections into the through openings or occur at least partly automatically during the installation of the flat gasket between the counter-surfaces to be sealed.

In one preferred embodiment of the invention, not only the projection of the first gasket layer but also the projection of the second gasket layer is deformed, so that the projections are centered between the gasket layers to be joined already in the production of the connection. Accordingly, the at least one projection of the second gasket layer is deformed at least in sections in a direction towards the plane of the first gasket layer until at least one outer margin portion of the projection comes to lie in a plane behind an adjacent outer margin portion of the projection of the first gasket layer. In the event that a projection of the first gasket layer and a projection of the second gasket layer are moved towards each other and past one another, it is appropriate to calk not merely one but both of the adjacent outer margin portions of the projections, This leads to the advantage that for producing an overlap between the two projections less material needs to be formed out in the later overlapping region from the outer margin portion of each of the projections than when calking merely one of the projections. The material strength in the formed boundary regions can therefore be larger and the connection is more stable. In view of the production of the metallic flat gasket, the bending of the projection out of its plane and the subsequent calking is also advantageous because both steps can be performed with one and the same tool.

A process is also disclosed. In one embodiment, a process for joining at least two gasket layers of the metallic flat gasket it is proceeded in such a way that a through opening is introduced into the first gasket layer in the connecting area, with at least one projection which projects into the interior of the through opening being left at first. A further through opening is introduced into the second gasket layer by also leaving at least one projection in the connecting area which projects into the interior of the through opening. The projections in the two gasket layers are arranged in such a way that when the first gasket layer and the second gasket layer are arranged above another, in a projection of the at least one projection of the second gasket layer into the plane of the first gasket layer, the projections of the first gasket layer do not overlap with the projections of the second gasket layer. Thereafter, the first and second gasket layer are arranged above one another in such a way that the projections do not overlap each other. Thereafter, the at least one projection of the first gasket layer is deformed at least partly from its plane in the direction towards the second gasket layer until at least one outer margin portion of the projection comes to lie in a plane behind an adjacent outer margin portion of a projection of the second gasket layer. Finally, at least one of said adjacent outer margin portions is calked, so that the projection of the first gasket layer grasps behind the projection of the second gasket layer in the region of the adjacent outer margin portions.

As already mentioned in the description of the metallic flat gasket itself, the at least one projection of the first gasket layer and the at least one projection of the second gasket layer can be moved towards each other and past one another in the process in accordance with the invention until at least mutually adjacent outer margin portions of the projections come to lie behind one another.

As already described in view of the metallic flat gasket, it is principally sufficient to calk merely one of the adjacent outer margin portions of the projection of the first gasket layer or the projection of the second gasket layer, so that an overlap is achieved in this region. It is preferable however, in order to produce the undercut, to calk both one outer margin portion of the projection of the first gasket layer and an outer margin portion of the projection of the second gasket layer.

The process in accordance with the invention is preferably carried out with a calking tool, comprising two tool parts, of which one is arranged on the side of the first gasket layer and the second on the side of the second gasket layer. Stamps projecting beyond the tool forming surface are, present in the known manner in all regions of the tool forming surface which correspond to such regions of the projection which are to be calked. When the tool parts are closed, said stamps come to lie on a respective outer margin portion of a projection and deform said outer margin portion in the direction towards the other gasket layer. In the course of the closing process, the formed outer margin portion is finally clamped between stamp of the one tool part and counter-surface of the other tool part. A further closure of the two tool parts leads to the consequence that the material of the clamped outer margin portion of the projection deforms in a plastic manner. The material of the projection is pressed out into a provided displacement space between the two tool parts. Said displacement space is arranged in such a way that the material which is pressed into the same forms an undercut to an outer margin portion of an adjacent projection of the other gasket layer.

The stamps in the calking tool can be attached to only one of the tool parts, but preferably to both tool parts. When the stamps are attached merely to one of the two tool parts, the undercut connections are formed at first in such a way that the undercutting regions project beyond the surface of one of the gasket layers. In order to enable the production of the undercut connections by calking, respective recesses are provided in the tool parts not provided with stamps, which recesses provide displacement spaces for the calked material. As already mentioned, the excess of material produced in this case can be removed at a later time forming the material into the through openings in the connecting area. In order to avoid any excess of material beyond the surfaces of the gasket layers right from the beginning, it is preferable to provide stamps on the tool forming surfaces of both tool parts in order to deform the projections of the first gasket layer as well as the projections of the second gasket layer and to produce undercut connections in the interior of the through openings in the connecting area. Apart from the particularities as described above, the calking tool used in the process in accordance with the invention and the performance of this process correspond to what is common practice in the state of the art.

The metallic flat gasket in accordance with the invention can consist of merely two gasket layers which are joined to each other in the manner as described above. It is also possible that more than two gasket layers are present in the gasket, They can either be joined to each other in such a way that two gasket layers each are joined as described above, with one gasket layer each being joined at least at one connecting point with the one adjacent gasket layer and at least at another connecting point with the other adjacent gasket layer, so that in total all gasket layers are joined into an interconnected unit. It is also possible to connect more than two gasket layers via a single connecting point. For this purpose, all superimposed gasket layers are each provided with a through opening in the connecting area. The projections which are used for joining the gasket layers are present in the gasket layers arranged on the outside. The connection is made in the manner as described above, with the connections joined by the undercut reaching through all through openings of the superimposed gasket layers.

In order to ensure a secure fixing of the gasket layers to each other it is appropriate to provide several connecting areas on the gasket layers. If permitted by the overall size of the gasket layers, at least three connecting areas are present on the gasket layers.

The shape of the through openings in the connecting area and the shape of the projections reaching into the through openings can principally be made at will. Preferably, the projections are provided with a tab-like or tongue-like configuration. The through openings and projections are appropriately only arranged with such a size as is necessary to produce a stable connection of the gasket layers. Otherwise, the connecting areas would become unnecessarily large and thus require more space than necessary on the gasket layer. The outer margin portions of the projections of the first and second gasket layer overlapping in the undercut can principally lie in any desired areas of the projections, e.g. on a lateral edge of the projections or in the area of their tip, adjacent to the interior of the through opening. A further exemplary geometrical combination for the connection of two gasket layers provides T-like projections in the first gasket layer and tab-like projections in the second gasket layer. Ideally, the open sections of the bottom side of the T-beam are adjacent to the side of a tab-like projection which faces to the center of the through opening. The outer margin portions overlapping in the undercut can lie on the lateral edges of the projections as in the above examples and/or on the bottom side of the T-beam and the side of the tab-like projections facing to the center of the through openings.

In an especially simple variant, the through openings in the superimposed gasket layers are provided with a rectangular configuration for example. One projection each is present per through opening, which projection covers only a partial area of the associated through opening. The projections of the superimposed gasket layers are offset relative to each other in such a way that in a top view of one of the gasket layers substantially the entire surface area of the through openings is covered. The projections are appropriately connected on their narrow sides each of the through opening with their associated gasket layer, while the remaining sides of the projection are released from the gasket layer. The connection of the two projections is made via the narrow-side boundary portions in the interior of the through openings. For the purpose of producing the connection, at least one of the projections is deformed from its plane in the direction towards the other projection until its edge on the narrow side comes to lie in a plane behind the edge on the narrow side of the other projection. Preferably, both projections are formed out of their plane until the edges on the narrow side are moved past each other. Then at least one of these edge regions is calked in order to thus produce the undercut in the area of the edges on the narrow side.

With this simple variant of the invention it is also possible to achieve a favorable fixing and positioning of the gasket layers relative to each other, especially when arranging several of these connections in the area of the gasket layers. An especially preferred positioning and fixing of the sealing layers is achieved when more than one projection is present per through hole in the connecting area. Especially preferably there are at least three and preferably four projections in the circumferential direction along the edge of a though hole. These projections are appropriately essentially evenly distributed in the circumferential direction. The projections of the first gasket layer are arranged in a laterally offset manner relative to the projections of the second gasket layer. When the projections of the one gasket layer are projected into the plane of the projections of the other gasket layer, one projection of the one gasket layer alternates in the circumferential direction with a projection of the other gasket layer without the projections overlapping before the calking. A lateral margin portion of a projection of the first gasket layer comes to lie adjacent to a lateral margin portion of a projection of the second gasket layer. The distance between the adjacent lateral margins is appropriately as small as possible, so that during the calking only relatively little material needs to be pressed out of the lateral margin portions of the projections in order to produce the undercut connection. The arrangement of the projections of the first and second gasket layer is preferred in such a way that a closed ring is obtained in the projection into a plane. The ring preferably concerns a circular ring. Accordingly, the projections at the edge of the through opening have a larger width than in the interior of the opening.

In the case of an arrangement of several projections per through opening, the projections within the opening of the same gasket layer as well as the projections in the different gasket layers can be shaped differently. For reasons of easier production it is preferable when all projections have the same shape and size. This means that the areas in the first through openings in which the projections of the second gasket layer come to lie must substantially have the same shape as the projections themselves. The boundary shape of the through opening of the first gasket layer and the through opening of the second gasket layer with the projections reaching into them therefore preferably correspond to one another. Merely the arrangement in the respective gasket layer differs. The through openings with the projections projecting into the same are staggered with respect to each other in such a way that a projection of the first gasket layer comes to lie above a respective set-off of the second gasket layer. Such an arrangement comes with the advantage that for introducing the through openings only a single tool needs to be used. When one changes from the production of the first gasket layers to the production of the second gasket layers, it is merely necessary to change the orientation of the tool relative to the gasket layer. The through openings are appropriately punched, which can optionally occur in the same step like the punching of further openings into the gasket layers. The step of introducing the through openings can be integrated in a simple and cost-effective way in the usual production steps of a metallic flat gasket like the further steps in the production of the layer connections.

The process in accordance with the invention for connecting at least two gasket layers of a metallic flat gasket is moreover suitable for a large number of different flat gaskets. A modification of the outer shape of the gasket layers such as the attachment of connecting flaps is not necessary, because the layer connections can be arranged in the pressing area of the gasket. Moreover, even coated gasket layers can be processed because a non-conductive coating of the gasket layer will not cause any disturbances in the process in accordance with the invention as is not the case concerning a welded connection. Examples of flat gaskets are cylinder head gaskets, manifold gaskets or other flange gaskets as are used especially in the field of combustion engines.

### BRIEF DESCRIPTION OF THE DRAWINGS

The invention will be explained below by reference to the enclosed drawings. The drawings are merely schematic and are used exclusively for explaining a number of preferred embodiments and process variants without limiting the invention to the same. The drawings, in which the same reference numerals designate the same parts, show as follows:

FIG. 1(a) shows a partial top view of a first gasket layer of a preliminary stage of a metallic flat gasket in accordance with the invention;

FIG. 1(b) shows a cross-sectional view through the gasket layer according to FIG. 1(a) along the line A-A;

FIG. 2(a) shows a partial top view of a second gasket layer of a preliminary stage of a metallic flat gasket in accordance with the invention;

FIG. 2(b) shows a cross-sectional view through the second gasket layer along line A-A in FIG. 2(a);

FIG. 3(a) shows a partial top view of the superimposed first and second gasket layers according to FIGS. 1(a) and 2(a) as a further preliminary stage of a metallic flat gasket in accordance with the invention;

FIG. 3(b) shows a cross-sectional view through the preliminary stage according to FIG. 3(a) along line A-A;

FIG. 4(a) shows a partial top view of a metallic flat gasket in accordance with the invention;

FIG. 4(b) shows a partial cross-sectional view through the metallic flat gasket according to FIG. 4(a) along the line A-A, and

FIG. 5 shows a preliminary stage of a metallic flat gasket in accordance with the invention during its production, arranged in a calking tool.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

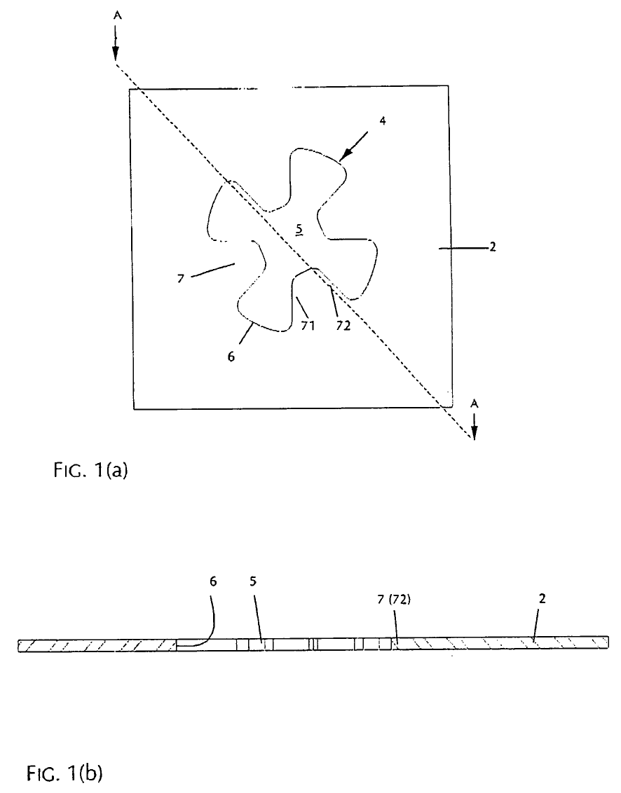

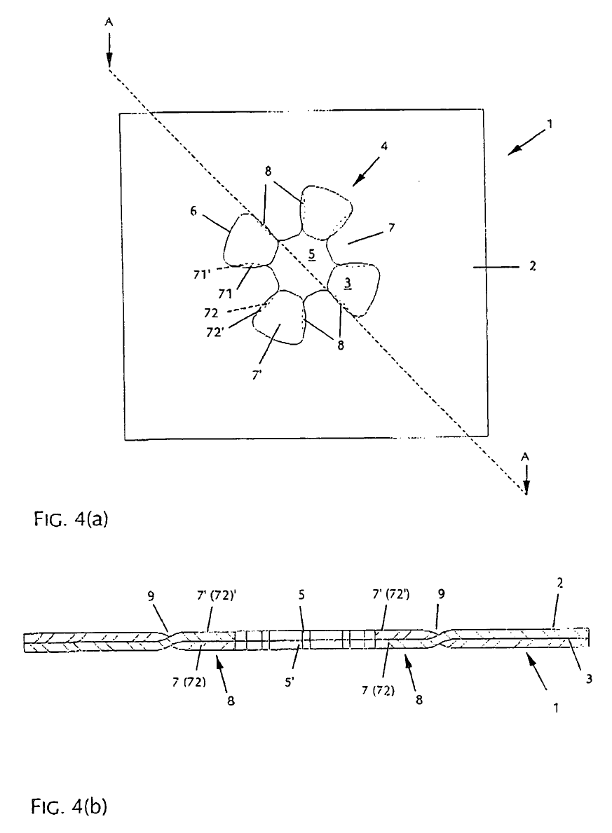

FIGS. 1(a) through 3(b) show different preliminary stages of a metallic flat gasket 1 in accordance with the invention, as shown in FIGS. 4(a) and 4(b). The partial illustration concerning a connecting area 4 is shown, in which different gasket layers 2 and 3 of the metallic flat gasket 1 are joined with each other.

FIGS. 1(a) and 1(b) show a preliminary stage of a first gasket layer 2. The material of the gasket layer 2 is stainless steel, for example. In the pressing area of gasket layer 2, i.e. in an area which comes to lie between the counter-surfaces to be sealed in the installed state of the finished metallic flat gasket 1, an opening 5 is introduced, e.g. it is punched in. Four projections 7 project beyond the edge 6 in the circumferential direction about the opening 5, which edge would have a substantially circular shape without the projections 7. In one embodiment, the projections 7 are provided with a tongue like configuration and taper towards the interior of the opening 5. In one embodiment, the projections 7 are evenly distributed in the circumferential direction about the opening 5 and are each respectively offset relative to each other by an angle of approximately 90°.

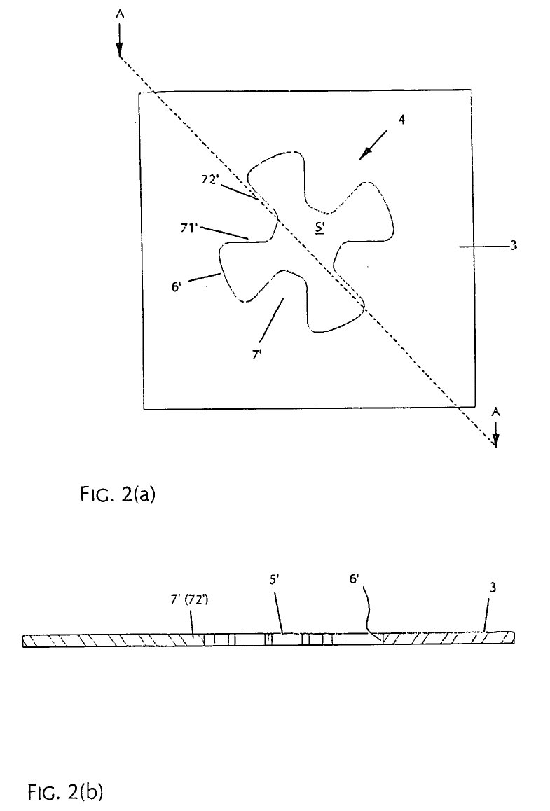

FIGS. 2(a) and 2(b) show a sectional view of a second sealing layer 3 as a further preliminary stage of the flat gasket 1 in accordance with the invention. These figures show the same sectional view as in FIGS. 1(a) and 1(b). Through opening 5′ and projections 7′ and the course of the edge 6′ of the through openings 5′ substantially correspond to those of gasket layer 2. In contrast to these however, the through opening 5′ with the projections 7′ is turned by approximately 45° a relative to the opening 5 and the projections 7 of the gasket layer 2.

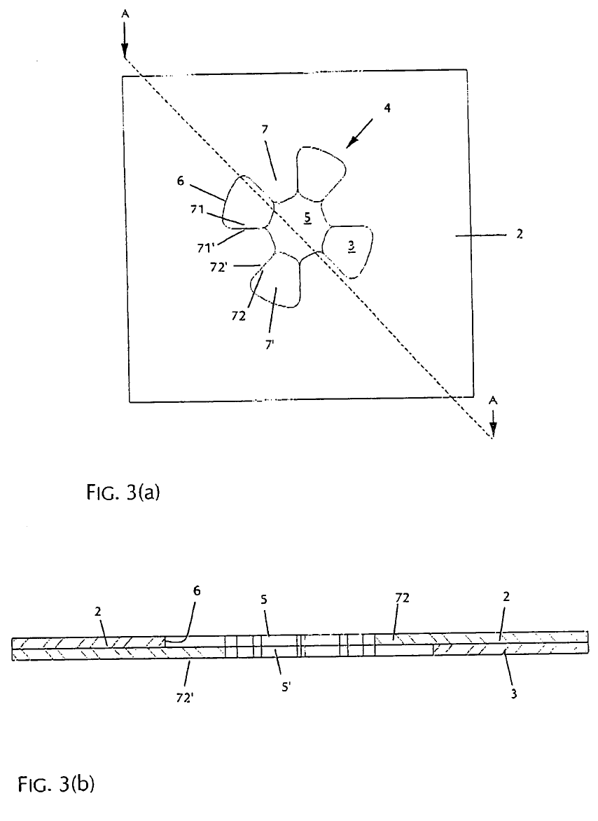

When the gasket layer 2 is arranged above the gasket layer 3 as is shown in FIG. 3(a) and FIG. 3(b), then this leads to the consequence that the projections 7 come to lie above the set-offs of the opening 5′ and the projections 7′ of the gasket layer 3 are arranged in an area beneath the set-offs in the opening 5 of the gasket layer 2. Accordingly, an outer margin portion 71 of each of the projections 7 of the gasket layer 2 comes to lie adjacent to an outer margin portion 71′ of the projections 7′ of the gasket layer 3 and a lateral margin portion 72 of the gasket layer 2 adjacent to a lateral margin portion 72′ of the gasket layer 3. FIGS. 3(a) and 3(b) show a preliminary stage of the flat gasket in accordance with the invention, in which the gasket layers 2 and 3 are not yet connected with each other.

In order to produce this connection, the lateral margin portions 71 and 72 of the projections 7 of the gasket layer 2 are deformed in the direction towards the gasket layer 3. Similarly, the lateral margin portions 71′ and 72′ of the gasket layer 3 are bent in the opposite direction towards the gasket layer 2. The deformation of the lateral margin portions occurs until the lateral margin portions 71 And 72 come to lie in a plane behind the lateral margin portions 71′ and 72′ of the gasket layer 3 and vice-versa. In this intermediate stage, the two gasket layers 2 and 3 are still not connected with each other. The connection of the two gasket layers occurs in such a way that the lateral margin portions 71, 72, 71′, 72′ are now calked. As a result, the material of the lateral margin portions flows laterally beyond the projections 7 and 7′. This can be seen in FIG. 4(a) in such a way that the progress of the lateral margin portions is no longer linear as in the preceding figures, but that the lateral margin portions 71 and 72 of the projections 7 and 71′ end 72′ of the projections 7′ are positioned curved to the outside. As a result of this widening of the projections 7 and 7′ to the outside, an overlapping of the projections occurs in the areas 8. In these overlapping areas 8 there is thus an undercut of the one gasket layer by the other one, as is shown clearly in FIG. 4(b). But bending out the outer margin portions 72 and 72′ as shown here from their respective plane there will be a crossing each of the two gasket layers 2 and 3 in the areas 9, so that in the overlapping areas 8 the second gasket layer 3 lies above the first gasket layer 2. In the overlapping areas 8, the gasket layer 2 therefore undercuts the gasket layer 3, so that both gasket layers are clamped with each other. In total, the projections 7 and 7′ form an annular area about the now reduced through openings 5 and 5′ with a total of eight undercut areas 8 in which the two gasket layers 2 and 3 are connected with each other. The number and arrangement of these undercut areas ensure on the one hand a very secure fastening of the gasket layers 2 and 3 to each other and on the other hand a stationary fixing of the two gasket layers towards one another.

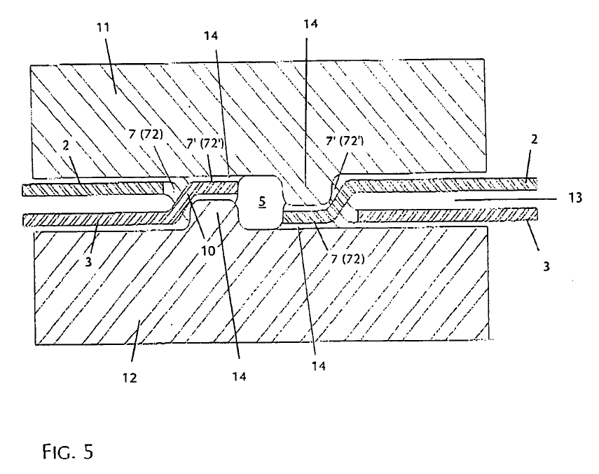

FIG. 5 shows a calking tool as can be used in the process in accordance with the invention for joining gasket layers of a metallic flat gasket. A partial cross section through the tool is shown, comprising an inserted preform of a metallic flat gasket in a partial sectional view in a connecting area of the gasket. The cross section follows again line A-A in FIG. 3(a), with the preform of the gasket being shown in a later processing stage. The preform of the flat gasket with the two gasket layers 2 and 3 is placed in a cavity 13 between two tool parts 11 and 12 and is shown in a state directly before the calking of adjacent projections 7 and 7′. The projections 7 and 7, or more precisely their outer margin portions 72 and 72′, are each already bent out from the plane of their associated gasket layer 2 or 3 into the plane of the respective other gasket layer. An offset bend 10 each is produced by the bending up. The forming of the outer margin portions 72 and 72′ occur with the help of stamps 14 which project beyond the tool forming surfaces of the tool parts 11 and 12. FIG. 5 shows the situation in the process according to the invention in which the outer margin portions 72 and 72′ are bent up substantially completely from the planes of their gasket layers, but where no calking has occurred yet.

For calking the outer margin portions 72 and 72′, the two tool parts 11 and 12 are moved further towards one another. The stamps 14 continue to press increasingly into the material of the outer margin portions 72 and 72′ and press the same laterally in the direction towards the respectively adjacent outer margin portions of the projections of the other gasket layer which are adjacent in the circumferential direction about the opening 5. Two of these adjacent projections are indicated with their outer contour in the direction of view behind the hatched outer margin portions 72 and 72′ of the cross-sectional plane, as also two stamps 14. A displacement chamber is each defined between the stamps which are situated behind one another in the drawing and thus adjacent in the circumferential direction. The calked material of the outer margin portions 72 and 72′ is pressed into these displacement chambers until the outwardly pressed outer margin portions 72 and 72′ of the projections 7 and 7′ finally overlap and form an undercut connection. Stamps 14 are obviously also present over the outer margin portions 71 and 71′, but are not shown in this illustration. The displacement chambers correspond to the later overlapping areas 8 of the projections 7 and 7′.

In the completely closed state of the two tool parts 11 and 12 the height of gap 13 between the tool parts corresponds to the thickness of the finished metallic flat gasket 1. During the deformation and calking steps, the gasket layers 2 and 3 lie naturally on the tool forming surfaces. For better clarity of the figure, these parts are depicted in a stretched manner, thus with distances, which are not present in practice. As a result of the planar shaping of the partial tool surfaces (apart from the stamps 14), the surfaces of the outer margin portions 72 and 72′ are flush with the surfaces of the gasket layers 2 and 3, so that in the area of the connection of the two gasket layers 2 and 3 no excess material is produced. This allows also using the connections in the pressing area of the gasket.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

1-10. (canceled)

11. A metallic flat gasket, comprising:
at least two superimposed gasket layers, a first gasket layer and a second gasket layer, which are connected to each other within at least one connecting area of each gasket layer, each of the first and second gasket layers further having a through opening being provided in the respective first and second gasket layers and at least one projection extending from a margin of the respective through openings and into the interior of the respective through openings;
wherein the at least projection of each gasket layer is connected to the respective gasket layer with the connection between the first and second gasket layer in the connecting area being achieved by:
the at least one projection of the first gasket layer is designed so as to not overlap with the at least one projection of the second gasket layer in a projection into the plane of the second gasket layer;
wherein the at least one projection of the first gasket layer is deformed at least partially out of the plane of the first gasket layer in a direction towards the second gasket layer until at least one outer margin portion of the projection comes to line in a plane behind an adjacent outer margin portion of the at least one projection of the second gasket layer; and
wherein at least one of the adjacent outer margin portions being calked so that the projection of the first gasket layer grasps behind the projection of the second gasket layer within the area of the adjacent outer margin portions.

12. A metallic flat gasket according to claim 1 wherein the at least one projection of the second gasket layer is deformed additionally in the direction towards the plane of the first gasket layer until at least one outer margin portion of the projection comes to lie in a plane behind an adjacent outer margin portion of the projection of the first gasket layer.

13. A metallic flat gasket according to claim 12, wherein the at least one projection is provided with a tongue-like configuration.

14. A metallic flat gasket according to claim 1, wherein a plurality of projections are present in the circumferential direction along the edge of the through opening.

15. A metallic flat gasket according to claim 14, wherein the projections are spaced equidistance from one another around the edge of the through opening.

16. A metallic flat gasket according to claim 14, wherein the at least one projection is provided with a tongue-like configuration.

17. A metallic flat gasket according to claim 14, wherein the projections of the first gasket layer are arranged laterally offset relative to the projections of the second gasket layer, so that in the projection of the projections of one gasket layer into the plane of the projections of the other gasket layer, one lateral margin portion of each of a projection of the first gasket layer comes to lie adjacent to a lateral margin portion of a projection of the second gasket layer.

18. A metallic flat gasket according to claim 17, characterized in that the arrangement of the projections of the first and second gasket layers leads to a generally closed ring.

19. A metallic flat gasket according to claim 18, wherein the general closed ring has circular shape.

20. A metallic flat gasket according to claim 1, wherein the shape of the edges of the through opening of the first gasket layer and the through opening of the second gasket layer correspond respectively to the projections projecting into the same, but are turned by a predetermined angle with respect to one another in their arrangement in the respective gasket layer, so that one projection of the first gasket layer comes to lie above a set-off of the second gasket layer.

21. A process for connecting at least two gasket layers of a metal flat gasket, comprising the steps of:
a) placing a through opening in a connecting area of a first gasket layer, further including leaving at least one projection extending into the interior of the through opening;
b) placing a through opening in a connecting area of a second gasket layer (3), further including leaving at least one projection extending into the interior of the through opening in a manner that the at least one projection in a projection of the at least one projection in the plane of the first gasket layer, does not overlap with the at least one projection of the first gasket layer when the first gasket layer and the second gasket layer are placed on top of each other;
c) placing the first and second gasket layers (2, 3) on top of each other so that the projections do not overlap each other;
d) deforming the at least one projection of the first gasket layer at least partly out of the plane of the first gasket layer in a direction towards the second gasket layer until at least one outer margin portions of the projection comes to lie in a plane behind an adjacent outer margin portion of a projection of the second gasket layer, and
e) calking at least one of the adjacent outer margin portions so that the projection of the first gasket layer grasps behind the projection of the second gasket layer in the area of the adjacent outer margin portions.

22. A process according to claim 21, wherein the deforming and calking steps are carried out with a calking tool, comprising two tool parts, of which one is arranged on the side of the first gasket layer and the second on the side of the second gasket layer and with at least the first tool part comprising at least one stamp which extends beyond the tool forming surface and which upon closing of the tool parts comes to lie on an outer margin portion of a projection of the first gasket layer, deforms said outer margin portion in the further closure of the tool parts in the direction towards the second gasket layer and finally calks the outer margin portion in such a way that material from the outer margin portion is displaced laterally into a displacement chamber behind an adjacent outer margin portion of the second gasket layer, so that the projection of the first gasket layer grasps behind the projection of the second gasket layer in the area of the adjacent outer margin portions.

23. The process according to claim 22, wherein the second tool part comprises at least one stamp which extends beyond the tool forming surface and which comes to lie on an outer margin portion of a projection of the second gasket layer, deforms said outer margin portion in the further closure of the tool parts in the direction towards the first gasket layer and finally calks the outer margin portion in such a way that material from the outer margin portion is displaced laterally into a displacement chamber behind an adjacent outer margin portion of the first gasket layer, so that the projection of the second gasket layer grasps behind the projection of the first gasket layer in the area of the adjacent outer margin portions.
